(19) United States
(12) Patent Application Publication
(10) Pub. No.: US 2008/0068206 A1
(43) Pub. Date: Mar. 20, 2008

(54) EXTENDED PRESENCE INFORMATION AND INTEREST FLAG

(75) Inventors: Sumit Chakravarty, Seattle, WA (US); Ankur Chavda, Seattle, WA (US); Kelly E. Rollin, Seattle, WA (US); Eran Shtiegman, Redmond, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/532,410

(22) Filed: Sep. 15, 2006

(51) Int. Cl. G08B 5/22

(52) U.S. Cl. 340/825.36

(57) ABSTRACT

A method and system for providing extended presence information defined by third parties and for detecting when the extended information has changed significantly is provided. An extensible presence service defines a presence document for a publishing user having a section reserved for extended information provided by one or more third parties and publishes the presence document to a presence server. Subscribing users send subscription requests to the presence server to receive updates when the presence document for the publishing user changes. When the extended information provided by the third party is updated, the third party updates the extended information and indicates whether the change to the extended information is significant. Next, the presence server sends the updated presence document containing the updated extended information to subscribed users.

### BACKGROUND

Users of computing devices (e.g., laptops, cellular phones, and personal digital assistants) often need to communicate in real time. A common form of real-time communication is provided by instant messaging services. An instant messaging service allows participants at endpoints to send messages and have them received within a second or two by the other participants in a conversation. The receiving participants can then send responsive messages to the other participants in a similar manner. To be effective, a real-time conversation relies on the participants' becoming aware of, reviewing, and responding to received messages very quickly. This quick response is in contrast to conventional electronic mail systems in which the recipients of electronic mail messages respond to messages at their convenience.

When an initiating participant wants to start a real-time conversation, that participant needs to know whether the intended participants are available to respond in real time to a message. If not, then communication via conventional electronic mail, voice mail, or some other mechanism may be more appropriate. For example, if the computers of the intended participants are currently powered off, then a real-time conversation may not be possible. Moreover, if their computers are currently powered on, but the intended participants are away from their computers, a real-time conversation is also not possible. The initiating participant would like to know the availability of the intended participants so that an appropriate decision on the form of communication can be made.

Presence services provide this availability information. The availability status of an entity such as a computer system or a user associated with that computer system is referred to as “presence information.” Presence information identifies the current “presence state” of the user. Users make their presence information available to a presence service so that other users can decide how best to communicate with them. For example, the presence information may indicate whether a user is logged on (“online”) with an instant messaging server or is logged off (“offline”). Presence information may also provide more detailed information about the availability of the user. For example, even though a user is online, that user may be away from their computer in a meeting. In such a case, the presence state may indicate “online” and “in a meeting.”

A presence service may provide a presence server for distributing presence information. A publishing user (“publisher”) may run client software that provides their presence information to a presence server that then provides the presence information to subscribing users (“subscribers”). Thus, a presence server may use a subscriber/publisher model to provide the presence information for the users of the presence service. Whenever the presence information of a publishing user changes, the presence server is notified of the change by that user's client software and in turn notifies the subscribing users of the change. A subscribing user can then decide whether to initiate a real-time communication and the type to initiate based on the presence information of the intended participants. For example, if the presence information indicates that a publishing user is currently on a conference telephone call, then the subscribing user may decide to send an instant message, rather than place a telephone call, to the publishing user. RFC 2778, entitled “A Model for Presence and Instant Messaging,” is a specification relating to presence information in instant messaging systems. RFC 3856, entitled “A Presence Event Package for the Session Initiation Protocol,” is a specification relating to presence information using the Session Initiation Protocol (“SIP”).

Current presence services define the presence information that publishers can share with subscribers. If a third party wants to make additional presence information available to subscribers, the third party would need to develop their own presence-like service, or negotiate with the provider of the existing presence service to modify the service to provide the additional presence information. Such development or modification takes time and is often outside the expertise or business strategy of the developer of the existing presence service, which delays or prevents the delivery of new features to users of the presence service. For example, a company that provides global positioning systems (“GPS”) may want to offer real-time information about the location of each of a user's contacts. The company would have to develop a presence service to share this information with subscribers that is largely redundant with existing presence systems. Alternatively, the company would have to request that the existing presence service developer modify the presence service to distribute GPS information. In addition, even if the third party is able to provide their additional information to a presence service, it is difficult or impossible for the presence service to detect when the changes to the additional information are significant such that the user should be alerted.

### SUMMARY

A method and system for providing extended presence information defined by sources other than the developer of a presence service (i.e., a third party) and for detecting when the extended information has changed significantly is provided. An extensible presence system defines a presence document for a publishing user having a section reserved for extended information provided by one or more third parties. Extended information goes beyond the standard presence information normally contained in a presence document as defined by the developer of the presence service. The extensible presence system publishes the presence document to a presence server, thereby making it available to subscribers of the system. Subscribing users, such as contacts of the publishing user, send subscription requests to the presence server to receive updates when the presence document for the publishing user changes. When the extended information provided by the third party is updated, the third party causes the extended information in the presence document of the presence server to be modified. The third party may also indicate whether the change to the extended information is significant. The presence server sends the updated presence document containing the updated extended information to subscribing users. The extensible presence system may display extended information to subscribing users in a user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the extensible presence system in one embodiment.

FIG. 2 illustrates a display page of the user interface of the system containing a contact list in one embodiment.

FIG. 3 illustrates a display page of the user interface of the system containing a details card in one embodiment.

FIG. 4 is a table containing extended information provided by a third party to the extensible presence system in one embodiment.

FIG. 5 is a flow diagram that illustrates the processing of the receive third party information component of the system in one embodiment.

FIG. 6 is a flow diagram that illustrates the processing of the determine new information component of the system in one embodiment.

### DETAILED DESCRIPTION

A method and system for providing extended presence information defined by sources other than the developer of a presence service (i.e., a third party) and for detecting when the extended information has changed significantly is provided. An extensible presence system defines a presence document for a publishing user having a section reserved for extended information provided by one or more third parties. For example, the presence document may be formatted using XML, and may contain tags for marking information in the presence document as extended information from a third party. One example of third party extended information of a publisher is a link to the publisher's website. The publisher's employer may provide each employee with a website and publish a link to each employee's website with the employee's presence information. Extended information goes beyond the standard presence information normally contained in a presence document as defined by the developer of the presence service. The extensible presence system publishes the presence document to a presence server, thereby making it available to subscribers of the system. For example, the publishing user may use a SIP client to publish information using a SIP PUBLISH request. Subscribing users, such as contacts of the publishing user, send subscription requests to the presence server to receive updates when the presence document for the publishing user changes. For example, each subscribing user may use a SIP client to send a SIP SUBSCRIBE request to the presence server to create a subscription to the publishing user's presence document. When the extended information provided by the third party is updated, the third party causes the extended information in the presence document maintained by the presence server to be modified. For example, the third party may provide the extended information of a publishing user to an existing SIP client of the user, which publishes a presence document with the extended information to a presence server. Alternatively, the third party may communicate directly with the presence server to update the extended information of the presence document for the publishing user. The third party may also indicate whether the change to the extended information is significant. For example, the extended information may contain a flag that is true when the change to the extended information is substantial, or interesting, and false otherwise. The extensible presence system may allow the third party provider of the information to determine what constitutes a substantial change. For example, if the third party provides GPS information about the location of the publishing user, the third party may consider movements by the publishing user of less than a certain threshold (e.g., 100 feet) to be insubstantial. In this example, the third party would set the interest flag only if the publishing user moved more than 100 feet from the last time the interest flag was set. Next, the presence server sends the updated presence document containing the updated extended information to subscribing users. For example, the presence server may send a SIP NOTIFY request to each subscribing user containing the updated presence document. In this way, third parties are able to provide extended presence information without having to convince a developer of a presence service to modify their format of presence documents or to duplicate functions of the existing presence service. Third parties can also indicate when changes to information provided by the third party are substantial which allows subscribing users to receive accurate presence information, without having to be bothered by changes that are insignificant. A third party can provide multiple instances of extended information and multiple third parties can provide different extended information for the same user, with each instance of extended information having its own indication of whether the extended information is substantial.

In some embodiments, the extensible presence system receives third party information through an automation application programming interface (“API”) of a client software application of the presence service. For example, each publishing user may run instant messaging software, and the third party may interact with the instant messaging software through the API to publish updated extended information. This type of publication is useful when the information published by the third party is available at the publishing user's client. For example, the third party may publish information about the song that the publishing user is currently playing on the computer running the instant messaging software. Alternatively, the third party may publish extended information directly to a presence server, such as when the information is provided by a service. The extended information may be provided by a telephone company, a Microsoft Sharepoint server, a Microsoft Exchange server, a Microsoft MapPoint server, or by another service. For example, the extended information may be provided by a calendaring service that indicates the conference room a publishing user is located in when the publishing user is participating in a meeting.

In some embodiments, the extensible presence system displays information provided by third parties in the user interface of the client software of subscribing users. For example, the client software may provide a details card that is displayed when a subscribing user selects a contact and requests detailed information about the selected contact. The details card may contain both standard presence information provided by the extended information service, such as the contact's status, as well as extended information provided by a third party. For example, if an employer provides each employee with a website, the employer may provide a link to the website in each employee's extended presence information, and the extensible presence system may display the link to the employee's website on the employee's details card. The extended information may be displayed wherever information about a publishing user is displayed, such as next to a contact in the user's contact list, in the user's details card, in a dialog box for displaying members of an email distribution list, or in a list of search results based on a search for users. In some embodiments, the client software or other components of the presence system may store extended information flagged as substantial until the user views the extended information. The system may also reset the flag for extended information flagged as substantial under certain conditions, such as after a subscriber has viewed the extended information.

In some embodiments, the extensible presence system provides a mechanism for third parties to prevent extended information from being displayed in the user interface. For example, the third party may want to publish information that is consumed by an application provided by the third party at each end of the conversation. The information may not make any sense if displayed to the subscribing user, but may be important to provide a unique user experience. For example, the third party may publish encrypted information using a publisher's private key that is only available to subscribers having the publisher's public key. A separate application provided by the third party may be used by each subscriber in conjunction with the client software of the presence service to provide the key to decrypt the information and for viewing the decrypted information.

In some embodiments, the extensible presence system provides an indication in the user interface of the client software when information provided by a third party has changed significantly. For example, the extensible presence system may display an asterisk next to a subscribing user's contacts in the client software that have new extended information. As another example, the details card for a contact may contain an asterisk next to each section that has changed significantly, including a section containing extended information provided by a third party. The extensible presence system may rely on the interest flag specified by the third party to determine when extended information has changed significantly. The extensible presence system may also use other criteria to determine when information has changed significantly. For example, the extensible presence system may maintain a timestamp that indicates when extended information was last published, and may not indicate a change as significant if the information was not published within a threshold (e.g., the last 24 hours). This prevents a user who has not signed on to the system for a long time (e.g., a month) from being inundated with new information indications. The threshold may be a static amount, or may be dynamically determined based on attributes or activity of the subscribing user. The extensible presence system may also track when a subscribing user has viewed information published by a publishing user, and may not indicate that information is significant (even though the interest flag may be set) if the subscribing user has already seen the information.

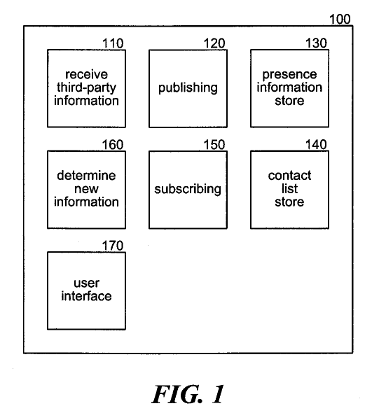

FIG. 1 is a block diagram that illustrates components of the extensible presence system in one embodiment. The system 100 contains a receive third party information component 110, a publishing component 120, a presence information store 130, a contact list store 140, a subscribing component 150, an attention determining component 160, and a user interface component 170. The receive third party information component 110 receives extended information from a third party to be made available to subscribing users. For example, the information may be received through an automation API or via a communication protocol to a presence server. The publishing component 120 publishes information, such as presence information and extended information, about a publishing user such that the information is available to subscribing users. The presence information store 130 stores published information about publishing users for notification to subscribing users. The presence information store 130 may also store the time of the last update to a publishing user's presence information. The contact list store 140 stores information about publishing users that a particular subscribing user has identified as contacts. The contact list store 140 may also store when each contact last viewed the particular user's presence information. The subscribing component 150 handles requests to subscribe to a publishing user's presence information and receives updated presence information when the publishing user's presence information changes. The attention determining component 160 examines received presence information to determine if the information is new such that it should be indicated to the subscribing user. For example, if the subscribing user has not previously seen the information, it may be considered new and an indication may be placed in the user interface to call the subscribing user's attention to the information. The user interface component 170 handles interaction with the user such as displaying a list of a subscribing user's contacts and displaying indications next to the contacts for which new presence information has been received.

The computing device on which the system is implemented may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

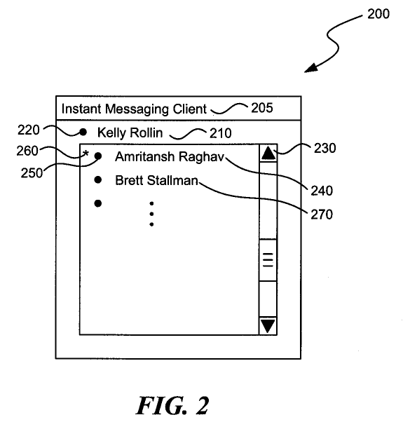

FIG. 2 illustrates a display page of the user interface of the system containing a contact list in one embodiment. The display page 200 includes a title bar 205, the name of the subscribing user 210, and an indication of the subscribing user's status 220, and a contact list 230. The contact list 230 contains a list of publishing users that the subscribing user has identified as contacts, for example a first contact 240, named Amritansh Raghav, and a second contact 270, named Brett Stallman, are listed. Next to each contact is an icon indicating the contact's status and optionally an indicator that is present when new information for the contact is available. For example, Amritansh 240 has an icon 250 that indicates he is online, and an indicator 260 that indicates new information is available. The indicator 260 may be a separate icon, as illustrated, or it may be any other mechanism that calls the publishing user's attention to a contact with new information. For example, the indicator could be an asterisk or arrow pointing to the contact, or the contact could flash or be displayed using a different color to indicate new information. New information may also be indicated outside the user interface, such as through a notification API accessible to other applications.

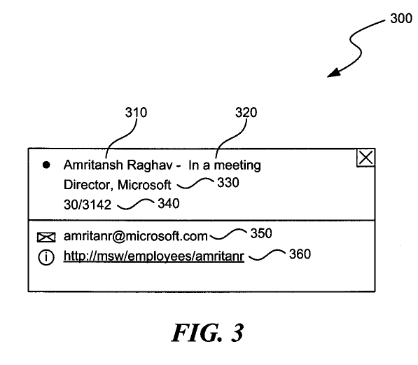

FIG. 3 illustrates a display page of the user interface of the system containing a details card in one embodiment. The display page 300 includes the name 310 of the user to whom the details card applies, the user's current status 320, the user's title 330, the user's office number 340, an email address 350, and extended information 360 specified by a third party. The display page 300 may contain various information other than what is illustrated in the Figure. For example, the display page 300 may contain alternative methods of reaching the user such as a cell phone number or work phone number. The display page 300 may also contain multiple pieces of information specified by one or more third parties in addition to the single piece of extended information 360 shown. In this example, the extended information 360 is a URL to a web page that the employee maintains with additional information about the employee.

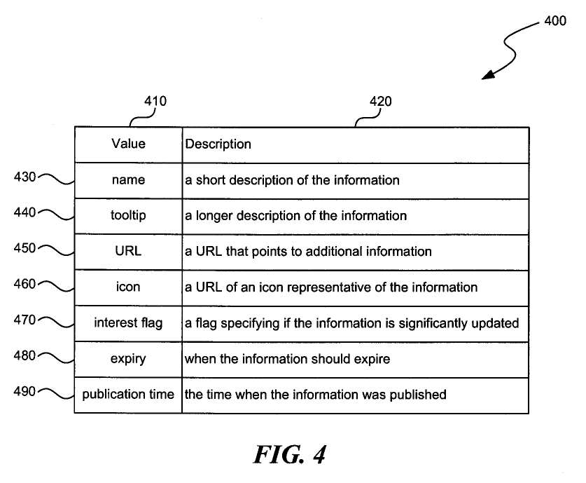

FIG. 4 is a table containing extended information provided by a third party to the extensible presence system in one embodiment. The information in the table 400 may be stored in a data structure used by the extensible presence system. The table contains a list of rows of information, each specifying a value 410 and a description 420 of the information stored by the value 410. The first row 430 contains a Name value that specifies a short description of the extended information that may be displayed to the user. The next row 440 contains a Tooltip value that specifies a longer explanation of the extended information. The next row 450 contains a URL value that specifies a location where additional information is located. The next row 460 contains an Icon value that specifies a URL to an icon that may be displayed in the user interface associated with the extended information. The next row 470 contains an Interest Flag value that specifies if the extended information has changed significantly. The next row 480 contains an Expiry value that specifies when the extended information should expire, and no longer be published. For example, the Expiry value may specify a specific time after which the information is stale, or may specify an event such as when the user signs off, after which the information should no longer be published. The next row 490 contains a Publication Time value that indicates when the extended information was published. The presence server may fill in this value automatically each time extended information is published by a third party.

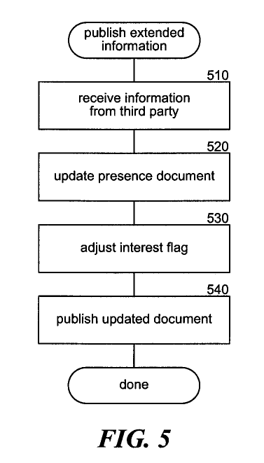

FIG. 5 is a flow diagram that illustrates the processing of the receive third party information component of the system in one embodiment. The component is invoked when a third party provides updated extended information. In block 510, the component receives extended information from a third party. In block 520, the component updates the presence document to contain the received information. In block 530, the component adjusts the interest flag based on whether the third party indicated that the information changed significantly. In block 540, the component publishes the updated presence document so that other users may receive the updated information. The component then completes.

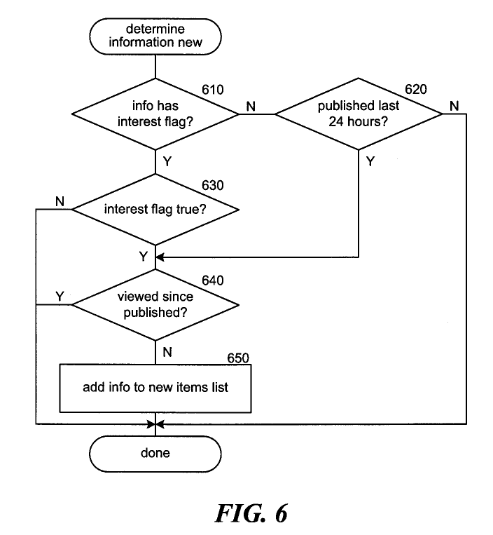

FIG. 6 is a flow diagram that illustrates the processing of the determine new information component of the system in one embodiment. The component is invoked to determine if updated extended information in a presence document is new such that an indication should be displayed to a subscribing user to call attention to the information. In decision block 610, if the extended information in the presence document contains an interest flag, then the component continues at block 630, else the component continues at block 620. In decision block 620, if the information was published in the last 24 hours, then the component continues at block 640, else the component completes to prevent a user who has not signed on to the system for a longer period of time from seeing an excessive number of new information indications. In decision block 630, if the interest flag value is true, then the component continues at block 640, else the component completes. In decision block 640, if the information has been viewed since it was last published, then the component completes, else the component continues at block 650. In block 650, the component adds the information to a list of new items for indication to the user.

From the foregoing, it will be appreciated that specific embodiments of the extensible presence system have been described herein for purposes of illustration, but that various modifications may be made without deviating from the spirit and scope of the invention. For example, although communications have been described using SIP, other suitable communication protocols could also be used. Similarly, although the system has been described as an enhancement to instant messaging systems, the system could also be used in other environments, such as to allow third parties to provide news, auction updates, or other information. Accordingly, the invention is not limited except as by the appended claims.

I/We claim:

1. A method in a presence system for publishing extended information provided by a third party, the method comprising:
generating presence information for a publishing user having standard information and extended information, the standard information being defined by the presence service and the extended information being defined by a third party;
receiving from subscribing users subscription requests to the presence information of the publishing user;
receiving a request to update the extended information; and
when the request to update the extended information is received,
updating the extended information of the presence information as requested; and
sending a notification containing the updated presence information including the updated extended information based on the received subscription requests.

2. The method of claim 1 wherein the third party provides the extended information through an automation API.

3. The method of claim 1 wherein the third party provides the extended information by communicating with a presence server.

4. The method of claim 1 wherein the request to update the extended information contains an indication of the significance of the updated extended information.

5. The method of claim 1 wherein the extended information contains geographic information.

6. The method of claim 1 wherein the extended information contains a website for the publishing user.

7. The method of claim 1 wherein the extended information contains an indication that the information should not be displayed in a user interface.

8. The method of claim 1 wherein receiving subscription requests and sending a notification are performed using SIP.

9. A computer-readable medium containing instructions for controlling a presence service to indicate to a subscriber significant extended information provided by a third party about a publisher, by a method comprising:
receiving presence information for a publisher having standard information and extended information, the standard information being defined by the presence service and the extended information being defined by a third party;
determining when the extended information was last updated;
determining if the extended information contains an indication that a substantial change to the extended information has occurred;
determining when the extended information was last viewed by the subscriber; and
when the extended information indicates that a substantial change has occurred and when the extended information has not been viewed by the subscriber since the extended information was last updated, indicating to the subscriber that the extended information is significant.

10. The computer-readable medium of claim 9 wherein the method further comprises if the extended information is older than a threshold, suppressing the indication to the subscriber.

11. The computer-readable medium of claim 9 including when the extended information indicates that a substantial change has occurred and when the extended information has already been viewed by the subscriber since the extended information was last updated, suppressing the indication to the subscriber.

12. The computer-readable medium of claim 9 wherein the indication to the subscriber is displayed in a contact list.

13. The computer-readable medium of claim 9 wherein the indication to the subscriber is provided through a details card.

14. The computer-readable medium of claim 9 wherein determining if the extended information contains an indication that a substantial change to the extended information has occurred includes determining if an interest flag is set.

15. The computer-readable medium of claim 14 including, after indicating to the subscriber that the information is significant, clearing the interest flag.

16. A computer system for displaying extended information provided by a third party, comprising:
a receive third party information component for receiving extended information about a publisher from a third party;
an attention determining component that determines whether extended information received from a third party should be brought to a subscriber's attention and
a user interface component for indicating to a subscriber when extended information has been received that should be brought to the subscriber's attention.

17. The system of claim 16 wherein the attention determining component determines that extended information should be brought to a subscriber's attention when the extended information was published within the last 24 hours.

18. The system of claim 16 wherein the attention determining component determines that extended information should be brought to a subscriber's attention when the extended information has not yet been seen by the subscriber.

19. The system of claim 16 wherein the attention determining component determines that extended information should be brought to a subscriber's attention when the extended information contains an indication that the information is significant.

20. The system of claim 16 wherein indicating to a subscriber includes displaying an indication in a contact list.
